(19) United States
(12) Patent Application Publication
(10) Pub. No.: US 2005/0040187 A1
(43) Pub. Date: Feb. 24, 2005

(54) Device for dispensing a product

(76) Inventors: Philippe Benivay, Eaubonne (FR); Gaetane Leboube, Paris (FR)

Correspondence Address: Thomas L. Irving;FINNEGAN, HENDERSON, FARABOW,, GARRETT & DUNNER, L.L.P., 1300 I Street, N.W., Washington, DC, 20005-3315, US

(21) Appl. No.: 10/869,916

(22) Filed: Jun. 18, 2004

Related U.S. Application Data
(60) Provisional application No. 60/485,121, filed on Jul. 8, 2003.

(30) Foreign Application Priority Data
Jun. 20, 2003 (FR) 03 07516
Jun. 27, 2003 (FR) 03 07801

(51) Int. Cl. G01F 11/06

(52) U.S. Cl. 222/321.1

(57) ABSTRACT

The present invention relates to a device (1) for packaging and dispensing a substance, in particular a cosmetic, the device comprising: a stationary portion;
a pushbutton (3) movable relative to the stationary portion, and serving to dispense a quantity of substance when actuated; and
a spring (4) comprising:
   an assembly portion (6) configured for fixing on the stationary portion, said assembly portion comprising at least one turn; and
   a projecting portion (7) extending along at least a portion of the pushbutton (3).

The present invention relates to devices for dispensing and packaging substances, in particular cosmetics, including care products.

Numerous substances, in particular perfumes, are packaged in flasks fitted with a pump enabling the substance to be dispensed in the form of a spray. The pump includes a pushbutton provided with a nozzle. In order to protect the pushbutton against being depressed accidentally, e.g. when the flask is transported in a handbag, a cap is fixed on the flask so as to cover the pushbutton. The drawback of such a cap is that it constitutes an additional part that can be lost and it obliges the user to remove it and then to replace it each time the device is used.

There exists a need for means reducing the risk of the pushbutton being depressed accidentally while the flask is being transported, but without excessively complicating manufacture of the device nor being detrimental to the appearance thereof.

The present invention satisfies this requirement in particular by proposing a device for packaging and dispensing a substance, in particular a cosmetic, the device being characterizable by the fact that it comprises:
a stationary portion;
a pushbutton movable relative to the stationary portion, and serving to dispense a quantity of substance when actuated; and
a spring comprising:
   an assembly portion configured for fixing on the stationary portion, said assembly portion comprising at least one turn; and
   a projecting portion extending along at least a portion of the pushbutton.

The term “pushbutton” should be understood broadly and covers a variety of forms of actuator member that the user can press in order to cause a quantity of substance to be dispensed.

The term “spring” should also be understood broadly, and covers parts having relatively small capacity for elastic deformation.

The projecting portion of the spring serves to reduce the risk of the pushbutton being depressed accidentally. The capacity of the spring to deform elastically makes it easier to mount on the stationary portion and confers a certain amount of strength to the projecting portion. The spring may be arranged so as to enable it to be secured releasably to the stationary portion, thus enabling the user to replace it with a cap or to reuse it on another flask. In a variant, the spring may be arranged in such a manner that the assembly portion is held on the stationary portion sufficiently strongly to prevent the spring being removed by a user exerting traction on the projecting portion.

In a particular embodiment of the invention, the projecting portion extends over a length which is greater than that of the pushbutton, so as to project beyond it.

The assembly portion may comprise a plurality of turns, which turns may optionally be touching, for example depending on the desired appearance effect.

The turns may present a circular shape when observed from the top or else, in particular oval or elliptic, and even substantially polygonal. The shape of the turns may be chosen in particular according to aesthetic considerations.

The spring may be made from a filament which may be a metal wire, in particular a spring steel wire of cross-section that is circular or other, in particular square or rectangular, likewise as a function of the desired appearance, where appropriate.

The assembly portion may comprise a plurality of turns all presenting the same section when seen from above, or presenting different sections, in particular different diameters if the turns are circular. A circular spiral shape can enable the assembly portion to turn relative to the stationary portion, for example to enable the user to orient the projecting portion relative to a substance-dispensing nozzle present in the pushbutton. The spring, in particular its assembly portion, need not include any purely helical winding.

The assembly portion may present a succession of turns of diameter that varies starting from one end of the assembly portion and going towards the other end of the assembly portion, passing through a single extremum, which extremum may be a minimum or a maximum, for example. The assembly portion may comprise, for example, at least one winding of frustoconical envelope, for example two successive windings each of frustoconical envelope and disposed in such a manner as to confer a substantially hourglass-shape on the assembly portion. In a variant, the assembly portion may present an envelope that is substantially conical, spherical, or cylindrical, for example.

The pushbutton may be movable along an axis. The assembly portion may extend along a longitudinal axis which may coincide substantially with the displacement axis of the pushbutton.

The projecting portion may be made in various ways, and in a particular embodiment of the invention, the projecting portion comprises a turn whose axis is at an angle relative to the axis of the assembly portion. This angle may be substantially a right angle.

The projecting portion may be made in particular in the form of a single turn. This turn may be connected directly to the adjacent turn of the assembly portion, however it could be disposed otherwise without thereby going beyond the ambit of the present invention, and the turn constituting the projecting portion could also be connected, for example, to at least one turn other than a turn situated at one end of the assembly portion. The turn constituting the projecting portion may present a section that is smaller than that of the turn(s) of the assembly portion. The section of this turn and its position relative to the pushbutton are preferably selected in such a manner that when the pushbutton includes a spray dispenser nozzle, the spray emitted by the nozzle does not encounter the turn. By way of example, the center of the turn may lie substantially in register with the nozzle at the halfway point in an actuation stroke of the pushbutton.

The device may include a flask having a neck and a pump suitable for fixing on the neck, e.g. by crimping or by snap-fastening. The flask may be made of glass, in particular.

The device may further include a hoop fixed on the neck of the flask or on the pump. The spring may be fixed to the hoop, e.g. being arranged to snap-fasten thereto. The hoop may include in particular an annular bead suitable for allowing at least one turn of the assembly portion to go past it, in particular by deforming elastically. The annular bead may be positioned in particular in such a manner as to be situated substantially between two turns of the assembly portion once the assembly portion of the spring is in place on the hoop. The hoop may include a collar at its base against which one end of the assembly portion may come to bear. The hoop may house a ring inserted in a groove defined by the above-mentioned collar. The hoop may be made of metal and the ring may be made of plastics material.

The face of the assembly portion that is to rest against the collar may include a portion that is substantially plane, e.g. a portion that has been ground flat.

The device may also include a pump presenting an assembly skirt snap-fastened on the neck of the flask. The assembly portion of the spring may be fixed directly to said assembly skirt, for example.

The invention also provides a device for packaging and dispensing a substance, in particular a cosmetic, the device comprising:
i) a receptacle containing the substance and including an opening;
ii) a dispenser element, in particular a pump or a valve, fitted to said opening;
iii) a dispenser head for actuating the dispenser element and delivering the substance to at least one outlet orifice, the dispenser head comprising a stationary portion and a pushbutton that is movable relative to the stationary portion; and
iv) a member configured in the form of a winding and comprising:
   a) at least a first turn occupying a plane and configured for fixing to the stationary portion of the dispenser head; and
   b) at least a second turn extending in a plane that is not parallel to the plane of the first turn and having a portion that extends relative to an axis above or level with an actuator surface of the pushbutton.

The invention can be better understood on reading the following detailed description of non-limiting embodiments thereof and on examining the accompanying drawings, in which:

FIG. 1 is a diagrammatic perspective view of an embodiment of a packaging and dispenser device made in accordance with the invention;

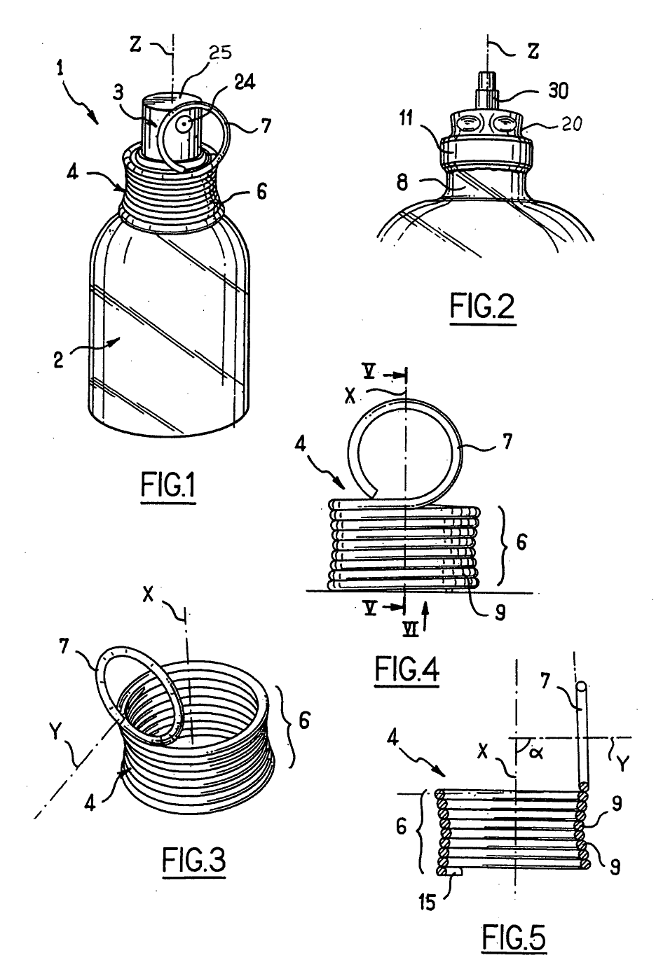

FIG. 2 is a fragmentary elevation view of the flask and the pump;

FIG. 3 shows the spring of the FIG. 1 device in isolation;

FIG. 4 is an elevation view of the FIG. 3 spring;

FIG. 5 is a longitudinal section view on V-V of FIG. 4;

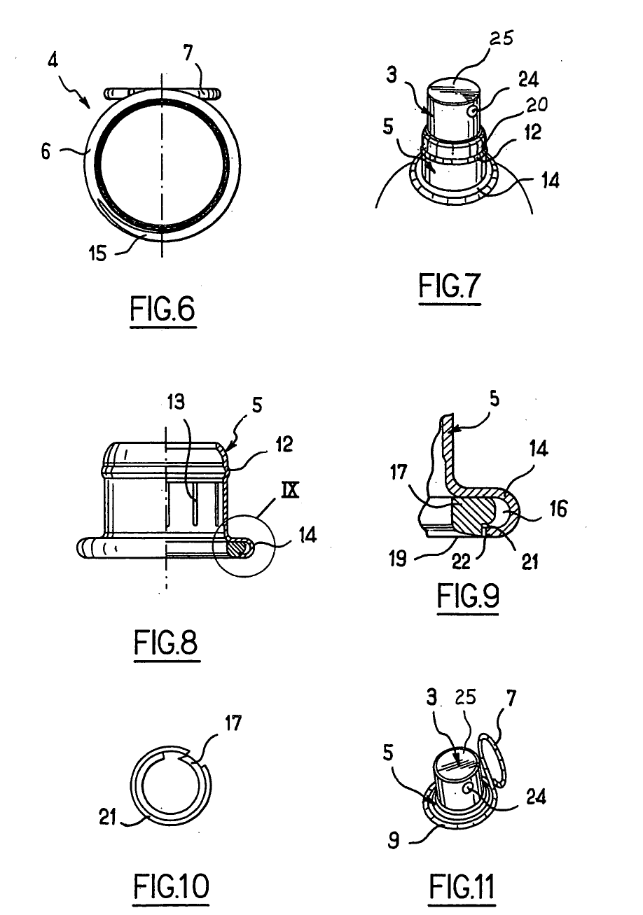

FIG. 6 is a view from beneath looking along VI of FIG. 4;

FIG. 7 shows a portion of the FIG. 1 device with the spring removed;

FIG. 8 shows the hoop of the FIG. 1 device in isolation and in axial half-section;

FIG. 9 shows a detail IX of FIG. 8;

FIG. 10 shows the ring for being received in the hoop, in isolation and in plan view;

FIG. 11 shows how the projecting portion of the spring can be offset angularly relative to the nozzle of the pushbutton;

FIG. 12 is a diagrammatic perspective view of a variant embodiment;

FIG. 13 is an exploded view of the FIG. 12 device; and

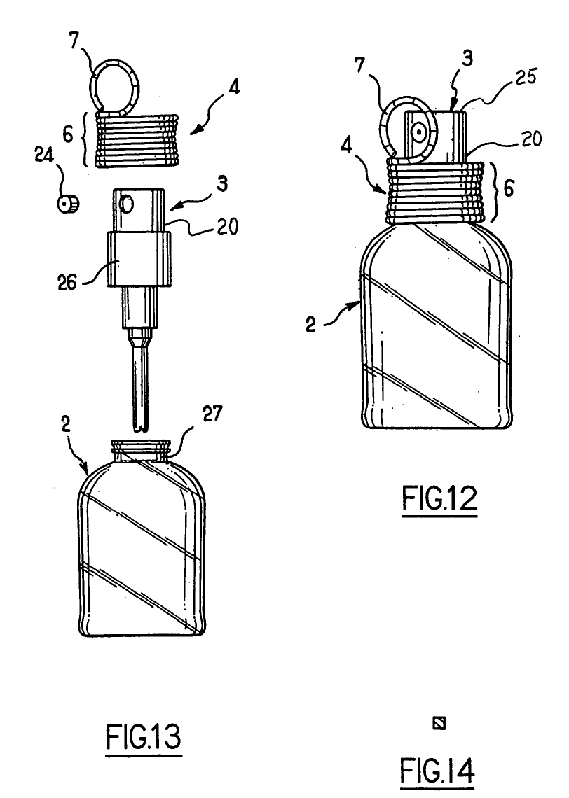

FIG. 14 shows an example of a square section.

FIG. 1 shows an embodiment of a packaging and dispenser device 1 made in accordance with the invention.

The device 1 comprises a fixed portion comprising a receptacle 2 which may be a flask made of glass or of plastics material and which is provided with a neck 8, which neck can be seen in FIG. 2. A hoop 5 is held by friction on the neck 8. The device 1 further comprises a moving portion constituted by the pushbutton 3 of a pump that is inserted in the neck 8 and that has a rod 30 that can likewise be seen in FIG. 2. The neck 8 is provided with an annular bead against which a metal capsule 11 is crimped for the purpose of fixing the pump body to the flask 2.

A spring 4 covers part of the hoop 5. The spring 4 comprises an assembly portion 6 for fixing on the hoop 5, and a projecting portion 7 which projects above the pushbutton 3, the assembly and projecting portions 6 and 7 being made as a single piece, by shaping a steel metal wire that is of circular cross-section in the example described. This wire may be subjected to heat treatment so as to give it a color, in particular a bluish color, or it may be polished so as to give it a shiny appearance.

The pushbutton 3 presents an actuator surface 30 which can be moved along an axis Z that coincides in the example described with the longitudinal axis of the flask 2. As can be seen more particularly in FIGS. 3 to 6, the projecting portion 7 in the example described is in the form of a single turn that is substantially circular and plane in shape, having an axis Y that is at an angle α of about 90° relative to the axis X of the assembly portion 6.

In the example shown, the assembly portion 6 comprises a plurality of touching turns 9, each of which is substantially circular in shape with the diameters of the turns initially decreasing and then increasing on moving along the axis X from the turn adjacent to the turn 7 towards the opposite end, so that the inside diameter of the assembly portion 6 passes through a minimum substantially halfway along its height.

The inside diameter of the turns 9 of the assembly portion 6 may be selected as a function of the degree of clamping desired for the spring 4 on the hoop 5.

The hoop 5 may be made out of a sheet of metal using at least one stamping operation and it may include, as can been in particular in FIGS. 7 and 8, an annular bead 12 defining a portion in relief onto which the assembly portion 6 can be snap-fastened, said annular bead 12 being capable, for example, of being received in the groove that is formed between two adjacent turns 9.

The hoop 5 may be made with longitudinal ribs 13 on its radially inner surface so as to apply friction on the capsule 11.

At its base, the hoop 5 presents a collar 14 presenting an inwardly-folded bottom rim 22. The spring 4 may press via its bottom face 15 against the collar 14. This bottom face 15 may advantageously be ground flat in a plane perpendicular to the axis X so as to enable it to rest against the collar 14 over substantially all of its circumference.

The collar defines an inwardly-open groove 16 suitable for receiving a split ring 17, shown in isolation in FIG. 10. The ring 17 presents a shouldered annular portion 21 suitable for engaging in the groove 16 above the rim 22 of the collar 14.

The ring 17 can serve to stiffen the collar 14 and to maintain its dimensions, and it can also contribute to centering the hoop 5 on the pump during manufacture of the device 1. In the example described, the ring 17 presents a bottom face 19 that is slightly conical, flaring downwards and outwards, and suitable for bearing against the shoulder situated at the base of the neck 8 of the flask 2, thus enabling it to act as a shock absorber when the hoop 5 is mounted on the flask 2, in the event of the hoop 5 being pushed down under insufficient control.

In the example described, the pushbutton 3 includes a nozzle 24 enabling the substance to be dispensed in the form of a spray. While the spring 4 is being put into place on the hoop 5, the turn 7 is preferably positioned facing the nozzle 24 so as to enable a spray to be dispensed through the turn 7. When the degree of clamping between the assembly portion 6 and the hoop 5 makes this possible, the user can, where appropriate, and if so desired, offset the turn 7 angularly relative to the nozzle 24, as shown in FIG. 11.

While the device 1 is being transported in a handbag, for example, the turn 7 which extends above the pushbutton 3 serves to prevent the pushbutton being depressed accidentally, e.g. by pressing against a wall of the bag.

Naturally, the invention is not limited to the example described.

By way of example, the device can be made without a hoop 5, it being possible for the spring 4 to be fixed directly on at least one of the pump and the neck of the flask.

By way of example, FIGS. 11 and 12 show a variant embodiment in which the pump presents an assembly skirt 26 arranged to snap-fastened on a portion in relief 27 on the neck of the flask 2, and in which the spring 4 is arranged so as to be fixed directly on the skirt 26. Such a configuration can make it easier to make the device at a size that is small.

In all of the above examples, the shape of the spring can be modified and in particular the spring could be made of wire that is square in section, as shown in FIG. 14.

The pump could be replaced by a valve, in which case the substance is contained inside the receptacle under pressure.

Throughout the description, including in the claims, the term “comprising a” should be understood as being synonymous with “comprising at least one”, unless specified to the contrary.

1. A device (1) for packaging and dispensing a substance, in particular a cosmetic, the device comprising:
a stationary portion;
a pushbutton (3) movable relative to the stationary portion, and serving to dispense a quantity of substance when actuated; and
a spring (4) comprising:
an assembly portion (6) configured for fixing on the stationary portion, said assembly portion comprising at least one turn (9); and
a projecting portion (7) extending along at least a portion of the pushbutton (3).

2. A device according to the preceding claim, characterized by the fact that the projecting portion (7) extends over a length which is greater than that of the pushbutton (3).

3. A device according to any preceding claim, characterized by the fact that the spring (4) is arranged to enable it to be fixed removably on the stationary portion.

4. A device according to claim 1 or claim 2, characterized by the fact that the spring is arranged in such a manner that the assembly portion (6) is clamped sufficiently tightly on the stationary portion to prevent the spring being removed by a user exerting traction on the projecting portion (7).

5. A device according to any preceding claim, characterized by the fact that the assembly portion (6) comprises a plurality of turns (9).

6. A device according to the preceding claim, characterized by the fact that the turns (9) are touching turns.

7. A device according to claim 5 or claim 6, characterized by the fact that the turns (9) are circular or elliptical in shape when observed from above.

8. A device according to any preceding claim, characterized by the fact that the spring (4) is made of metal wire.

9. A device according to any preceding claim, characterized by the fact that the spring (4) is made of wire that is circular or square in cross-section.

10. A device according to any preceding claim, characterized by the fact that the assembly portion (6) comprises a plurality of turns (9) presenting sections that are different when seen from above.

11. A device according to the preceding claim, characterized by the fact that the assembly portion (6) comprises a succession of turns (9) of diameter that varies starting from one end of the assembly portion and going towards the other end of the assembly portion.

12. A device according to the preceding claim, characterized by the fact that the diameter passes through a single extremum.

13. A device according to the preceding claim, characterized by the fact that the extremum is a minimum.

14. A device according to any preceding claim, characterized by the fact that the pushbutton (3) is movable along an axis (Z), and by the fact that the assembly portion (6) extends along a longitudinal axis (X) that coincides substantially with the displacement axis (Z) of the pushbutton (3).

15. A device according to any preceding claim, characterized by the fact that the projecting portion comprises a turn (7), in particular a single turn, of axis (Y) that makes an angle (α) with the axis (X) of the assembly portion.

16. A device according to the preceding claim, characterized by the fact that the angle (α) is substantially a right angle.

17. A device according to claim 15 or claim 16, characterized by the fact that the turn (7) presents a section that is smaller than that of the turn(s) (9) of the assembly portion (6).

18. A device according to any preceding claim, characterized by the fact that it includes a flask (2) presenting a neck (8) and a pump which is fixed to the neck by crimping or snap-fastening.

19. A device according to any preceding claim, characterized by the fact that it further includes a hoop (5) fixed to the neck of the flask or to the pump.

20. A device according to the preceding claim, characterized by the fact that the spring (4) is snap-fastened to the hoop.

21. A device according to claim 19 or claim 20, characterized by the fact that the hoop (5) has a collar (14) at its base, against which one end of the assembly portion (6) can bear.

22. A device according to the preceding claim, characterized by the fact that the hoop (5) houses a ring (17) inserted in a groove defined by the collar (14).

23. A device according to any one of claims 19 to 22, characterized by the fact that the hoop (5) is made of metal.

24. A device according to claim 22, characterized by the fact that the ring (17) is made of plastics material.

25. A device according to claim 21, characterized by the fact that the assembly portion includes a face (15) for resting against the collar, comprising a substantially plane portion, in particular a portion ground flat.

26. A device according to any one of claims 1 to 18, characterized by the fact that it includes a pump presenting an assembly skirt (26) snap-fastened to the neck of the flask.

27. A device according to the preceding claim, characterized by the fact that the assembly portion (6) is fixed directly to the skirt (26).

28. A device for packaging and dispensing a substance, in particular a cosmetic, the device comprising:
i) a receptacle (2) containing the substance and including an opening;
ii) a dispenser element, in particular a pump or a valve, fitted to said opening;
iii) a dispenser head (5, 3; 26, 3) for actuating the dispenser element and delivering the substance to at least one outlet orifice, the dispenser head comprising a stationary portion (5; 26) and a pushbutton (3) that is movable relative to the stationary portion; and
iv) a member (4) configured in the form of a winding and comprising:
a) at least a first turn (9) occupying a plane and configured for fixing to the stationary portion of the dispenser head; and
b) at least a second turn (7) extending in a plane that is not parallel to the plane of the first turn and having a portion that extends relative to an axis (
c)X) above or level with an actuator surface (36) of the pushbutton.
